(19) United States
(12) Patent Application Publication
(10) Pub. No.: US 2015/0239742 A1
(43) Pub. Date: Aug. 27, 2015

(54) EXFOLIATION OF GRAPHITE USING IONIC LIQUIDS

(71) Applicant: THE BOARD OF TRUSTEES OF THE UNIVERSITY OF ALABAMA, Tuscaloosa, AL (US)

(72) Inventors: Rachel M. Frazier, Tuscaloosa, AL (US); Daniel T. Daly, Tuscaloosa, AL (US); Scott K. Spear, Bankston, AL (US); Robin D. Rogers, Tuscaloosa, AL (US)

(21) Appl. No.: 14/643,131

(22) Filed: Mar. 10, 2015

Related U.S. Application Data
(62) Division of application No. 13/130,657, filed on Sep. 9, 2011.
(60) Provisional application No. 61/117,590, filed on Nov. 25, 2008.

(51) Int. Cl. C01B 31/04; H01B 1/24

(52) U.S. Cl. CPC C01B 31/0469; C01B 31/0484; H01B 1/24

(57) ABSTRACT

Disclosed are methods of exfoliating graphite using one or more ionic liquids. Also disclosed is the exfoliated graphite and/or graphene provided by a disclosed method. Further disclosed are composites comprising exfoliated graphite and/or graphene and methods of making the composites.

### FIELD

The subject matter disclosed herein generally relates to graphite materials, and more specifically to the exfoliation of graphite using ionic liquids, methods related thereto, and composites comprising exfoliated graphite and/or graphene and methods of making same.

### BACKGROUND

Graphene is a thin layer of carbon with mechanical and electrical properties that can be useful in a number of applications, including mechanical and electrical applications (A. K. Geim and K. S. Novoselov, “The Rise of Graphene,” Nature Materials (2007), 6, 183-191). For example, graphene has been observed to exhibit a Young modulus of 1,000 GPa and a tensile strength of 60 GPa, which is several orders of magnitude higher than common engineering plastics. In addition, graphene has been observed to exhibit high electrical and thermal conductivity, with values close to or better than many metals. Graphene is also compatible with modern polymer processing techniques, which can allow for the creation of engineered materials incorporating graphene.

Graphene is typically produced through mechanical or chemical processing of graphite into single sheets. Graphene can be produced mechanically via a one step method wherein adhesion tape is applied to graphite and subsequently removed to provide graphene sheets. This method has a number of disadvantages including irreproducibility. Graphene can also be produced from graphite through chemical exfoliation. Unfortunately, however, current chemical exfoliation methods can require harsh treatments that can leave behind deleterious by-products. Many methods involve the oxidation of graphite into graphite-oxide to create a soluble graphite/graphene-oxide composition. The graphene-oxide is then exfoliated from the graphite, creating a suspension of graphene-oxide. The graphene-oxide is then reduced to graphene. This process inevitably leaves unfavorable graphene-oxide behind. Residual graphene-oxide interferes with many properties of graphene, including its conductivity and mechanical strength.

The intercalation and exfoliation of graphite has been studied. Common approaches to intercalating graphite include acid intercalation and alkali metal intercalation (Intercalation and exfoliation routes to graphite nanoplatelets J. Mater. Chem., 2005, 15, 974-978). Li ion battery research has resulted in the realization that the cation of ionic liquid electrolytes intercalates graphite electrodes (Pure ionic liquid electrolytes compatible with a graphitized carbon negative electrode in rechargeable lithium-ion batteries, Journal of Power Sources (2006), 162(1), 658-662). Recently, ionic liquids (ILs) have been applied toward the electrochemical intercalation of graphite resulting in a precursor to functionalized graphene (N. Liu, F. Luo, H. Wu, Y. Liu, C. Zhang, and J. Chen, “One-step Ionic-Liquid-Assisted Electrochemical Synthesis of Ionic-Liquid-Functionalized Graphene Sheets Directly from Graphite,” Adv. Func. Mater. (2008), 18, 1518-1525). While the technology of Liu et al. bypasses the harsh chemical process described above, it requires an electrochemical step to intercalate a graphite electrode before the graphite is exfoliated.

Thus, there exists a need for methods and compositions that overcome some of problems in the art of graphene production, a few of which are aforementioned. Disclosed herein are compositions and methods that meet these and other needs.

### SUMMARY

In accordance with the purposes of the disclosed materials, compounds, compositions, articles, devices, and methods, as embodied and broadly described herein, the disclosed subject matter, in one aspect, relates to compositions and methods for preparing exfoliated graphite, graphene, and methods of use thereof. In a further aspect, the disclosed subject matter relates to composites comprising exfoliated graphite and graphene, e.g., polymer composites. In a still further aspect, the disclosed subject matter relates to the use of one or more ionic liquids in combination with a disclosed method, composition, composite, and the like.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 is a TEM image of an exfoliated sample of graphite (A) with a scaled-up portion of the image (B) displaying a graphene sheet.

FIG. 2 is a TEM image of a synthetic graphite starting material (not-exfoliated, as-received from Aldrich).

FIGS. 3A and 3B are TEM images of a portion of a polystyrene/graphene/graphite composite film.

FIG. 4 is a photograph of three graphene/ionic liquid suspensions (from left to right: 1-butyl 3-methylimidazolium chloride, 1-hexyl 3-methylimidazolium chloride, and 1-decyl 3-methylimidazolium chloride with suspended graphene).

### DETAILED DESCRIPTION

The materials, compounds, compositions, articles, devices, and methods described herein may be understood more readily by reference to the following detailed description of specific aspects of the disclosed subject matter and the Examples included therein and to the Figures.

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not. For example, the phrase “L is an optional linker” means that L may or may not be present in the composite and that the description includes both composites where L is present (e.g., linking a first active substance to a second active substance) and composites where L is not present, in which case the first and second active substances are directly bonded together.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed as “less than or equal to” the value, “greater than or equal to the value” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

### Chemical Definitions

As used herein, the term “graphene” is meant to refer to hexagonal carbon. In one aspect, graphene includes 10 layers of hexagonal carbon, or less, including, for example, individual sheets of graphene. The terms “exfoliated graphite” is contemplated to include 11 layers of hexagonal carbon, or more. For example, exfoliated graphite can include 11 layers of more of graphite that has been intercalated and subsequently removed from bulk graphite. The term “exfoliate,” as used herein, refers to an expansion of a bulk graphite lattice. The term “graphite” is meant to include intercalated graphite, exfoliated graphite, and in some aspects, graphene.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “alkyl” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “alkoxy” as used herein is an alkyl group bound through a single, terminal ether linkage; that is, an “alkoxy” group can be defined as —OA¹ where A¹ is alkyl as defined above.

The term alkoxylalkyl as used herein is an alkyl group that contains an alkoxy substituent and can be defined as -A¹-O-A², where A¹ and A² are alkyl groups.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This may be presumed in structural formulae herein wherein an asymmetric alkene is present, or it may be explicitly indicated by the bond symbol C═C. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “alkynyl” as used herein is a hydrocarbon group of 2 to 24 carbon atoms with a structural formula containing at least one carbon-carbon triple bond. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl. The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above, and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” is a short hand notation for C═O.

The terms “amine” or “amino” as used herein are represented by the formula NA¹A²A³, where A¹, A², and A³ can be, independently, hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” as used herein is represented by the formula —C(O)O⁻.

The term “ester” as used herein is represented by the formula —OC(O)A¹ or —C(O)OA¹, where A¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula A¹OA², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula A¹C(O)A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” as used herein refers to the halogens fluorine, chlorine, bromine, and iodine.

The term “hydroxyl” as used herein is represented by the formula —OH.

The term “nitro” as used herein is represented by the formula —NO₂.

The term “silyl” as used herein is represented by the formula —SiA¹A²A³, where A¹, A², and A³ can be, independently, hydrogen, alkyl, halogenated alkyl, alkoxy, alkenyl, alkynyl, aryl, heteroaryl, cycloalkyl, cycloalkenyl, heterocycloalkyl, or heterocycloalkenyl group described above.

The term “sulfo-oxo” as used herein is represented by the formulas —S(O)A¹, —S(O)₂A¹, —OS(O)₂A¹, or —OS(O)₂OA¹, where A¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above. Throughout this specification “S(O)” is a short hand notation for S═O

The term “sulfonyl” is used herein to refer to the sulfo-oxo group represented by the formula —S(O)₂A¹, where A¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “sulfonylamino” or “sulfonamide” as used herein is represented by the formula —S(O)₂NH—.

The term “sulfone” as used herein is represented by the formula A¹S(O)₂A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “sulfoxide” as used herein is represented by the formula A¹S(O)A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “thiol” as used herein is represented by the formula —SH.

“R¹,” “R²,” “R³,” “Rⁿ,” where n is an integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

References to “mim,” “Cₙ-mim,” and “bmim” are intended to refer to a methyl imidazolium compound, an alkyl methyl imidazolium, and a butyl methylimidazolium respectively.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture.

Reference will now be made in detail to specific aspects of the disclosed materials, compounds, compositions, articles, and methods, examples of which are illustrated in the accompanying Examples and Figures.

### Materials and Compositions

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or can be prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989). In general, graphite can be derived from a natural source or from a synthetic source. It should be appreciated that the disclosed methods can be independent of the size or nature of the starting graphite.

Also, disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components A, B, and C are disclosed as well as a class of components D, E, and F and an example of a composition A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

In one aspect, provided are efficient and facile routes to the intercalation and exfoliation of graphite into nanometer-thick particles or even thinner graphene. Usual exfoliation of graphene relies on the conversion of graphite to graphite-oxide via harsh chemical treatment. The graphite-oxide is exfoliated to provide thin graphene-oxide, which is then chemically treated to return to un-oxidized graphene. By contrast, the inventive methods use ionic liquids to intercalate graphite which allows direct exfoliation of the graphite. The disclosed graphene-ionic liquid compositions can be incorporated into many existing technologies. For example, the graphene-ionic liquid compositions and methods for use therewith can be used to provide conductive polymer films.

### Ionic Liquid (IL)/Graphite Compositions

In one aspect, a composition can be provided comprising graphite and at least one ionic liquid. Such compositions can be used in accordance with the disclosed methods to provide exfoliated graphite and/or graphene. In one aspect, the graphite can be synthetic graphite, such as, for example, synthetic graphite available from Sigma-Aldrich (St. Louis, Mo). In one aspect, a composition has a desired weight percent of graphite relative to the total composition. For example, a composition can comprise from about 0.01% to about 1% graphite by weight of the total composition, or from about 0.01% to about 0.5% graphite, or from about 0.01% to about 0.2% graphite.

In a further aspect, a composition can comprise at least one ionic liquid. In general, the present invention can be compatible with a variety of ionic liquids. However, it will be apparent that ionic liquids of differing composition can affect the solubility limit and particle size of the exfoliated graphite/graphene.

In one aspect, the ionic liquids of the present invention can be any ionic liquid and/or can comprise any properties suitable for use in the various aspects of the present disclsoure. In a further aspect, the ionic liquids can contain one or more ionized species (i.e., cations and anions) and can have a melting point usually below about 150° C. In some cases the ionic liquids can be organic salts containing one or more cations that are typically ammonium, imidazolium, or pyridinium ions, although many other types are known and disclosed herein. It should be noted that, in various aspects, multiple ionic liquids of varying composition can be used. In one aspect, the ionic liquid can be a surfactant or have surfactant like properties. In another aspect, the ionic liquid is not a surfactant.

In one aspect, the hydrophilic ionic liquid solution used herein can be substantially free of at least one of water, a water-or alcohol-miscible organic solvent, or nitrogen-containing base. In another aspect, the hydrophilic ionic liquid solution can be substantially free of all of water, a water-or alcohol-miscible organic solvent, and nitrogen-containing base. Contemplated organic solvents of which the solution is free include solvents such as dimethyl sulfoxide, dimethyl formamide, acetamide, hexamethyl phosphoramide, water-soluble alcohols, ketones or aldehydes such as ethanol, methanol, 1-or 2-propanol, tert-butanol, acetone, methyl ethyl ketone, acetaldehyde, propionaldehyde, ethylene glycol, propylene glycol, the C₁-C₄ alkyl and alkoxy ethylene glycols and propylene glycols such as 2-methoxyethanol, 2-ethoxyethanol, 2-butoxyethanol, diethyleneglycol, and the like.

A cation of a hydrophilic ionic liquid can be cyclic and can, in various aspects, correspond in structure to any one or more of the formulae shown below:

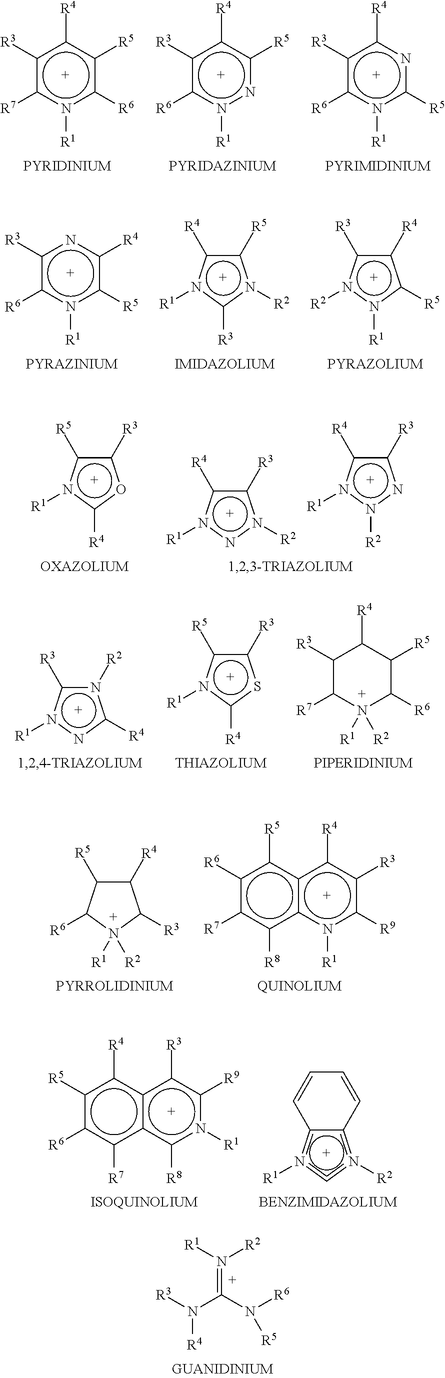

wherein R¹ and R² are independently a C₁-C₆ alkyl group or a C₁-C₆ alkoxyalkyl group, and R³, R⁴, R⁵, R⁶, R⁷, R⁸, R⁹ (R³-R⁹), when present, are independently H, a C₁-C₆ alkyl, a C₁-C₆ alkoxyalkyl group, or a C₁-C₆ alkoxy group. In other examples, both R¹ and R² groups are C₁-C₄ alkyl, with one being methyl, and R³-R⁹, when present, are H. Exemplary C₁-C₆ alkyl groups and C₁-C₄ alkyl groups include methyl, ethyl, propyl, iso-propyl, butyl, sec-butyl, iso-butyl, pentyl, iso-pentyl, hexyl, 2-ethylbutyl, 2-methylpentyl, and the like. Corresponding C₁-C₆ alkoxy groups contain the above C₁-C₆ alkyl group bonded to an oxygen atom that is also bonded to the cation ring. An alkoxyalkyl group contains an ether group bonded to an alkyl group, and here contains a total of up to six carbon atoms. It is to be noted that there are two iosmeric 1,2,3-triazoles. In some examples, all R groups not required for cation formation can be H.

The phrase “when present” is often used herein in regard to substituent R group because not all cations have all of the numbered R groups. All of the contemplated cations contain at least four R groups, which can be H, although R² need not be present in all cations.

In one aspect, the phrases “substantial absence” and “substantially free” are used synonymously to mean that less than about 5 weight percent water is present, for example. In other aspects, less than about one percent water is present in the composition. The same meaning is intended regarding the presence of a nitrogen-containing base, water, or alcohol miscible organic solvent.

An anion for a contemplated ionic liquid cation is a halogen (fluoride, chloride, bromide, or iodide), perchlorate, a pseudohalogen such as thiocyanate and cyanate or C₁-C₆ carboxylate. Pseudohalides are monovalent and have properties similar to those of halides (Schriver et al., Inorganic Chemistry, W. H. Freeman & Co., New York, 1990, 406-407). Pseudohalides include the cyanide (CN), thiocyanate (SCN), cyanate (OCN), fulminate (CNO), and azide (N₃) anions. Carboxylate anions that contain 1-6 carbon atoms (C₁-C₆ carboxylate) and are illustrated by formate, acetate, propionate, butyrate, hexanoate, maleate, fumarate, oxalate, lactate, pyruvate, perfluoroalkyltrifluoroborate, hexafluorophosphate anion, bis(perfluoroethylsulfonyl)imide anion, pentafluorophenyl imide ions, bis((trifluoromethyl)sulfonyl) amide, bis(perfluoroalkylsufonyl)imide, tris(perfluoralkyl)trifuorophosphates, bis(trifluoromethylsulfonyl) imide, alkyl sulphonates, trihalids and mixed trihalides, alkylphosphates, alkylphosphonates, alkylthiophosphonates, and the like. Still other examples of anions that can be present in the disclosed compositions include, but are not limited to, sulfate, sulfites, phosphates, phosphites, nitrate, nitrites, hypochlorite, chlorite, perchlorate, bicarbonates, triflates, and the like, including mixtures thereof.

Some additional examples of ionic liquids include, but are not limited to, the following quaternary ammonium salts: Bu₄NOH, Bu₄N(H₂PO₄), Me₄NOH, Me₄NCl, Et₄NPF₆, and Et₄NCl.

The contemplated solvent can also comprise mixtures of two, or more, of the contemplated ionic liquids.

In one example, all R groups that are not required for cation formation; i.e., those other than R¹ and R² for compounds other than the imidazolium, pyrazolium, and triazolium cations shown above, are H. Thus, the cations shown above can have a structure that corresponds to a structure shown below, wherein R¹ and R² are as described before.

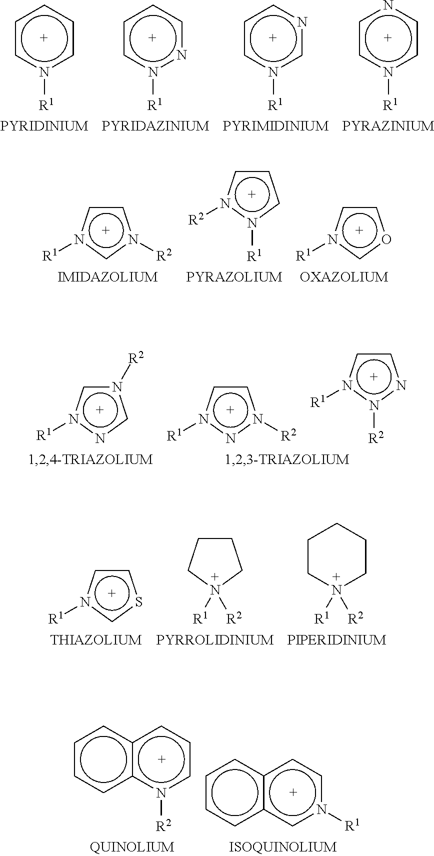

A dissolution method is also contemplated using an ionic liquid comprised of those cations. That method comprises admixing graphite with a hydrophilic ionic liquid comprised of those five-membered ring cations and anions in the substantial absence of water to form an admixture. The admixture is agitated until exfoliation is attained. Exemplary cations are illustrated below wherein R¹, R², and R³-R⁵, when present, are as defined before.

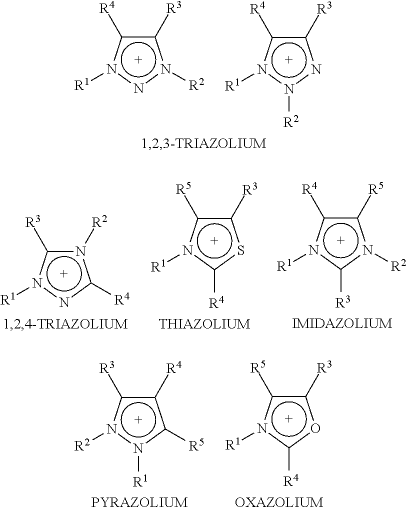

Of the cations that contain a single five-membered ring free of fusion to other ring structures, an imidazolium cation that corresponds in structure to Formula A is also suitable, wherein R¹, R², and R³-R⁵, are as defined before.

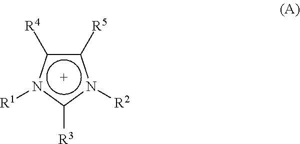

In a further example, an N,N-1,3-di-(C₁-C₁₆ alkyl)-substituted-imidazolium ion can be used; i.e., an imidazolium cation wherein R³-R⁵ of Formula A are each H, and R¹ and R² are independently each a C₁-C₁₆ alkyl group or a C₁-C₁₆ alkoxyalkyl group. In still other examples, a 1-(C₁-C₁₆-alkyl)-3-(methyl)-imidazolium [Cₙ-mim, where n=1-16] cation and a halogen anion can be used. In yet another example, the cation illustrated by a compound that corresponds in structure to Formula B, below, wherein R^{3 l -R}⁵ of Formula A are each hydrido and R¹ is a C₁-C₁₆-alkyl group or a C₁-C₁₆ alkoxyalkyl group.

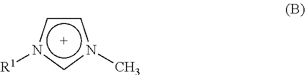

The disclosed ionic liquids can be liquid at or below a temperature of about 150° C., for example, at or below a temperature of about 100° C. and at or above a temperature of about minus 100° C. For example, N-alkylisoquinolinium and N-alkylquinolinium halide salts have melting points of less than about 150° C. The melting point of N-methylisoquinolinium chloride is 183° C., and N-ethylquinolinium iodide has a melting point of 158° C. In other examples, a contemplated ionic liquid is liquid (molten) at or below a temperature of about 120° C. and above a temperature of about minus 44° C. In some examples, a suitable ionic liquid can be liquid (molten) at a temperature of about minus 10° C. to about 100° C.

In one aspect, at least one ionic liquid comprises an optionally substituted imidazolium cation and at least one anion. For example, the optionally substituted imidazolium cation can be present as 1-alkyl 3-methylimidazolium, including 1-butyl 3-methylimidazolium chloride, 1-pentyl 3-methylimidazolium chloride, 1-hexyl 3-methyl imidazolium chloride, 1-heptyl 3-methylimidazolium chloride, 1-octyl 3-methylimidazolium chloride, 1-nonyl 3-methylimidazolium chloride, 1-decyl 3-methylimidazolium chloride, and 1-hexadecyl 3-methylimidazolium chloride.

An ionic liquid as disclosed herein can have an extremely low vapor pressure and can optionally decompose prior to boiling. Exemplary liquification temperatures (i.e., melting points (MP) and glass transition temperatures (T_{g})) and decomposition temperatures for illustrative N,N-1,3-di-C₁-C₆-alkyl imidazolium ion-containing ionic liquids wherein one of R¹ and R² is methyl are shown in Table 1 below.

TABLE 1

| | Liquification | Decomposition | |
|---|---|---|---|
| | Temperature | Temperature | |
| Ionic Liquid | (° C.) | (° C.) | Citation* |
| [C₂mim] Cl | | 285 | a |
| [C₃mim] Cl | | 282 | a |
| [C₄mim] Cl | 41 | 254 | b |
| [C₆mim] Cl | −69 | 253 | |
| [C₈mim] Cl | −73 | 243 | |
| [C₂mim] I | | 303 | a |
| [C₄mim] I | −72 | 265 | b |
| [C₄mim] [PF₆] | 10 | 349 | b |
| [C₂mim] [PF₆] | 58−60 | 375 | c, a |
| [C₃mim] [PF₆] | 40 | 335 | a |
| [iC₃mim] [PF₆] | 102 | | a |
| [C₆mim] [PF₆] | −61 | 417 | d |
| [C₄mim] [BF₄] | −81 | 403, 360 | d, e |
| [C₂mim] [BF₄] | | 412 | a |
| [C₂mim] [C₂H₃O₂] | 45 | | c |
| [C₂mim] [C₂F₃O₂] | 14 | About 150 | f |

a) Ngo et al., Thermochim Acta 2000, 357: 97.
b) Fanniri et al., J Phys Chem 1984, 88: 2614.
c) Wilkes et al., Chem Commun 1992, 965.
d) Suarez et al., J Chem Phys 1998, 95: 1626.
e) Holbrey et al., J Chem Soc, Dalton Trans 1999, 2133.
f) Bonhote et al., Inorg Chem 1996, 35: 1168.

### Methods

In one aspect, methods are provided for exfoliating graphite, thereby providing exfoliated graphite and/or graphene. In one aspect, graphite can be exfoliated using a disclosed composition. While not wishing to be bound by theory, it is believed that the ionic liquid of a disclosed composition can intercalate graphite, thereby allowing the formation of an at least partially homogenous solution of graphite and ionic liquid, and, subsequent exfoliation of graphite to provide exfoliated graphite and graphene, which can precipitate or suspend in the solution.

In one aspect, a method for making an exfoliated graphite and/or graphene comprises the steps of providing a mixture comprising graphite and at least one ionic liquid; substantially homogenizing the mixture by imparting sufficient energy to separate sheets within the graphite, thereby making the exfoliated graphite and/or graphene. In a further aspect, a substantially homogenized mixture can subsequently be substantially de-homogenized, such as, for example, by centrifugation, to enable the recovery and isolation of exfoliated graphite and/or graphene, if present. In a still further aspect, a mixture can be diluted, e.g., with water, prior to substantially de-homogenizing the mixture. In yet a further aspect, exfoliated graphite and/or graphene can be recovered and/or isolated from the de-homogenized mixture by known methods, such as, for example, by filtration.

In one aspect, substantially homogenizing the mixture comprises imparting energy to the mixture. In various aspects, such energy can be in the form of at least one of ultrasonic energy, electrical energy, mechanical energy, and the like, or a combination thereof. In a further aspect, imparting energy to the mixture can be accomplished by agitating the mixture. Any appropriate energy source can be used, such as, for example, ultrasonic energy (i.e., through sonication). In a still further aspect, substantially homogenizing the mixture comprises agitating (e.g., sonicating) the mixture for a period of time sufficient to substantially homogenize the mixture. The period of time can vary depending on sample size, concentration, among other factors. In one aspect, however, the period of time can be on the order of hours, such as for, example, from 1 to 10 hours.

In one aspect, imparting energy to the mixture does not comprise applying an electrical current to the mixture. It is contemplated that the graphite, in one aspect, will not be utilized as an electrode in a composition. Thus, in this aspect, imparting energy to the mixture does not comprise applying an electrical current to the graphite itself. In a further aspect, a method does not comprise applying an electrical potential difference between two graphitic electrodes, or even across at least one graphite electrode immersed in ionic liquid electrolyte.

Also disclosed is the exfoliated graphite and/or graphene made by a disclosed method. In one aspect, the exfoliated graphite and/or graphene can be substantially free of oxide (i.e., graphite oxide and/or graphene oxide) if, for example, a disclosed method does not comprise an oxidation step.

In a further aspect, disclosed methods relate to preparing polymer composites comprising exfoliated graphite and/or graphene. Such polymer composites can be used in any appropriate application, such as, for example, an electronic or thermoelectronic application, a light weight-high strength application, among others. In one aspect, a method for making a polymer composite comprising exfoliated graphite and/or graphene comprises the steps of: providing a first mixture comprising a polymer and a solvent; providing a second mixture comprising exfoliated graphite and/or graphene and at least one ionic liquid; and mixing the first mixture with the second mixture to provide a third mixture, thereby making the polymer composite comprising exfoliated graphite and/or graphene.

In a further aspect, providing the first mixture comprises the step of mixing the polymer with the solvent for a sufficient period of time to provide a homogenous mixture. It is contemplated that the polymer can be any polymer, such as for example, a polymer provided by a vinyl containing monomer. Examples of such polymers include optionally substituted polystyrenes, optionally substituted polyethylenes, polypropylenes, polyphenylene vinylene, a light emitting polymer including a fluorescing, phosphorescing, or otherwise luminescent polymer.

Other examples include polymers of copolymers of: 2-(4-tert-butylphenyl)-5-(4-biphenylyl)-1,3,4-oxadiazole, 1,3,5-tris(2-(9-ethylcabazyl-3)ethylene)benzene, 1,3,5-tris[3-methylphenyl)phenylamino]benzene, 1,4-bis(diphenylamino)benzene, 4,4′-bis(N-carbozolyl)-1,1′-biphenyl, 4-(diethylamino)benzaldehyde diphenylhydrazone, 9-ethyl-3-carbazolecarboxaldehyde diphenylhydrazone, Copper(II) phthalocyanine, N,N′-bis(3-methylphenyl)-N,N′-diphenylbenzidine, N,N′-di-[(1-napthyl)-N,N′-diphenyl]-1,1′-biphenyl)4,4′diamine, N,N′-diphenyl-N,N′di-p-tolylbenzene-1,4-diamine, poly(copper phthalocyanine), tetra-N-phenylbenzidine, titanyl phthalocyanine, titanyl phthalocyanine β-modification, tri-p-tolylamine, tris(4-carbozoyl-9-ylphenyl)amine, tris[4-(diethylamino)phenyl]amine, 2-(4-biphenylyl)-5-phenyl-1,3,4-oxadiazole, 2-(4-tert-butylphenyl-5-5(4-biphenylyl)-1,3,4-oxadiazole, 3,5-Bis(4-tert-butylphenyl)-4-phenyl-4H-1,2,4-triazole, 3-(biphenyl-4-yl)-5-(4-tert-butylphenyl)-4-phenyl-4H-1,2,4-triazole, Bathocuproine, Bathophenanthroline, and Tris-(8-hydroxyquinoline)aluminum, 2,3,5,6-Tetrafluoro-7,7,8,8-tetracyanoquinodimethane, 2-[4-((4-(Bis(2-hydroxyethyl)amino)phenyl)(cyano)methylene)-2,5-cyclohexadien-1-ylidene]malonitrile, 7,7,8,8-Tetracyanoquinodimethane.

Still other examples of polymers or copolymers thereof include Poly(3,4-ethylenedioxythiophene), bis-poly(ethyleneglycol), lauryl terminated, Poly(3,4-ethylenedioxythiophene), Poly(3,4-ethylenedioxythiophene)-block-poly(ethylene glycol), Poly(3,4-ethylenedioxythiophene)-poly(styrenesulfonate), Poly(thiophene-3-[2-(2-methoxyethoxy)ethoxy]-2,5-diyl), sulfonated, Polyaniline (emeraldine salt), Tetracyanoethylene, Poly(3-dodecylthiophene-2,5-diyl), Poly(3-hexylthiophene-2,5-diyl), Poly(3-octylthiophene-2,5-diyl), Poly[(9,9-di-n-octylfluorenyl-2,7-diyl)-alt-(benzo[2,1,3]thiadiazol-4,8-diyl)], Poly[(9,9-dioctylfluorenyl-2,7-diyl)-co-bithiophene], Poly[2-methoxy-5-(2-ethylhexyloxy)-1,4-phenylenevinylene], Poly[2-methoxy-5-(3′,7′-dimethyloctyloxy)-1,4-phenylenevinylene], Poly(2,5-di(hexyloxy)cyanoterephthalylidene), Poly(2,5-di(octyloxy)cyanoterephthalylidene), Poly(2,5-di(3,7-dimethyloctyloxy)cyanoterephthalylidene), Poly(5-(2-ethylhexyloxy)-2-methoxy-cyanoterephthalylidene), Poly(5-(3,7-dimethyloctyloxy)-2-methoxy-cyanoterephthalylidene), Poly(benzimidazobenzophenanthroline), Poly[(1,4-divinylenephenylene)(2,4,6-triisopropylphenylborane)], Poly[(2,5-didecyloxy-1,4-phenylene)(2,4,6-triisopropylphenylborane)], diphenyl terminated.

It is also contemplated that the polymer can be any electron or hole transporting or injecting material, any organic semiconductor or conducting polymer, or a block copolymer thereof.

In a further aspect, providing the second mixture comprises the steps of: providing a precursor mixture comprising graphite and at least one ionic liquid; and substantially homogenizing the precursor mixture, thereby providing the second mixture comprising exfoliated graphite and/or graphene.

In a still further aspect, an organic solvent can be added to the second mixture to provide a polymer composite solution. It should be appreciated that such steps, including but not limited to, adding organic solvent to the exfoliated graphite and/or graphene-ionic liquid mixture, and like steps, are within routine experimentation and optimization.

In one aspect, the precursor mixture is an ionic liquid (IL)/graphite composition as disclosed herein. Thus, in one aspect, the methods for using the IL/Graphite Compositions to provide exfoliated graphite and/or graphene can be used in combination with the methods for making polymer composites. In one aspect, for example, substantially homogenizing the precursor mixture comprises imparting energy to the mixture. Imparting energy can be carried out as aforementioned, such as, for example, by agitation and/or sonication.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

All chemicals used were of analytical grade, purchased from Sigma-Aldrich (Milwaukee, Wis.), and used without further purification unless otherwise noted.

### Example 1

### Exfoliation of Synthetic Graphite (1)

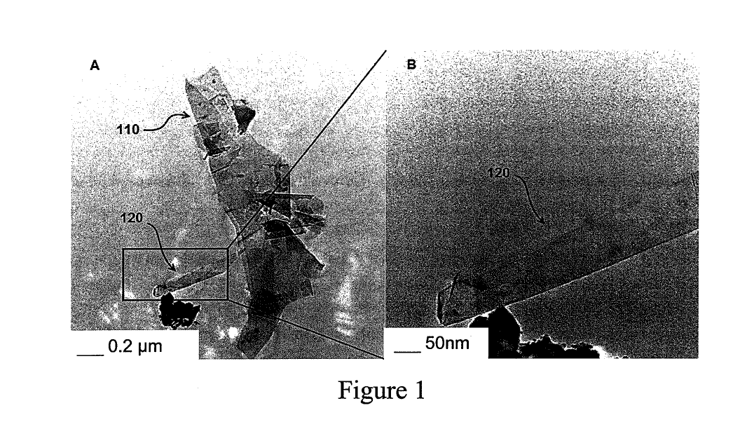

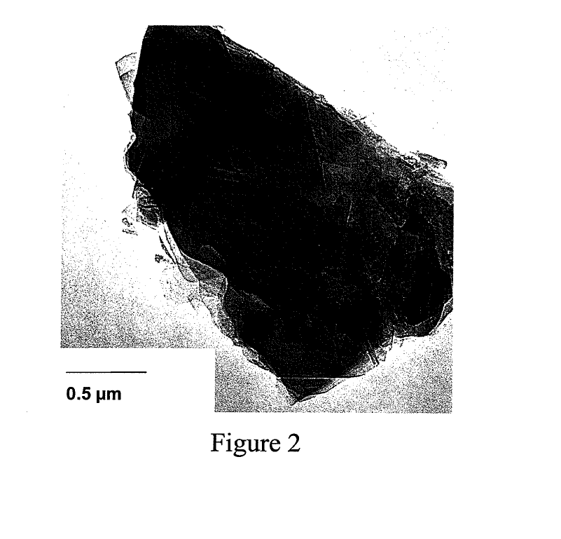

Approximately 0.01 wt % synthetic graphite was added to 1-butyl 3-methylimidazolium chloride and sonicated for ˜1hr. After exfoliation occurred, as evidenced by a homogeneous solution, part of the resulting composite solution was diluted with deionized water and centrifuged. Transmission electron microscopy (TEM) was used to image the resulting particles. With reference to FIG. 1, exfoliated graphite 110 and graphene sheets 120 were found in the sample. For comparison, FIG. 2 shows the as-received Aldrich synthetic graphite. The remaining exfoliated graphite and/or graphene-ionic liquid suspension was left for more than 6 months without apparent agglomeration.

### Example 2

### Exfoliation of Synthetic Graphite (2)

Approximately 0.015 wt % graphite in 1-hexa 3-methylimidazolium chloride and approximately 0.016 wt % graphite in 1-deca 3-methylimidazolium chloride were sonicated 1 hour. More exfoliated graphite and/or graphene particles were suspended in these solutions when compared to the solution of 1-butyl 3-methylimidazolium chloride and exfoliated graphite and/or graphene, with fewer precipitates at bottom of vessel. The exfoliated graphite and/or graphene remained suspended for more than 6 months.

### Example 3

### Preparation of a Polystyrene/Graphene/Graphite Composite Film

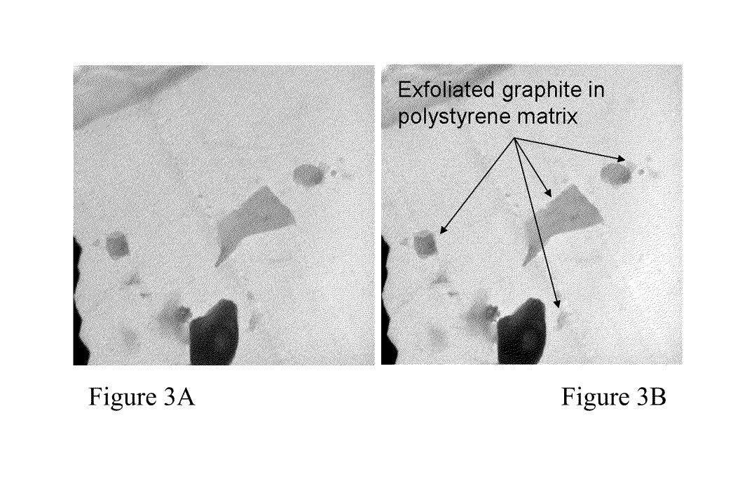

The composite solution from Example 1 was used to incorporate graphene into polystyrene (PS). Three mL of a 3.72 wt % mixture of polystyrene in dimethylformamide (DMF) was sonicated for 5 minutes to create a homogenous solution. 10 wt % of dimethylformamide was added to a 0.01wt % solution of exfoliated graphite and/or graphene in 1-butyl 3-methylimidazolium chloride and sonicated. The DMF/exfoliated graphite and/or graphene/ionic liquid solution was dropwise added to the PS/DMF solution while sonicating. The polystyrene precipitated out as the The DMF/exfoliated graphite and/or graphene/ionic liquid solution was added. The two-phase system was sonicated for ˜5 minutes and the polystyrene was removed from solution and rinsed with deionized water. A section was cut and evaluated with TEM. The exfoliated graphite and/or graphene was incorporated into the polystyrene during the processing with no external driving force other than the attraction of like phases. TEM shows that approximately the same amount of graphene to exfoliated graphite is incorporated into the polystyrene as was present in the original solution. FIG. 3 shows TEM images of the polystyrene/graphene/exfoliated graphite composite. As shown, exfoliated graphite 310 and graphene 320 are present in the composite.

### Example 4

### Varying Ionic Liquid

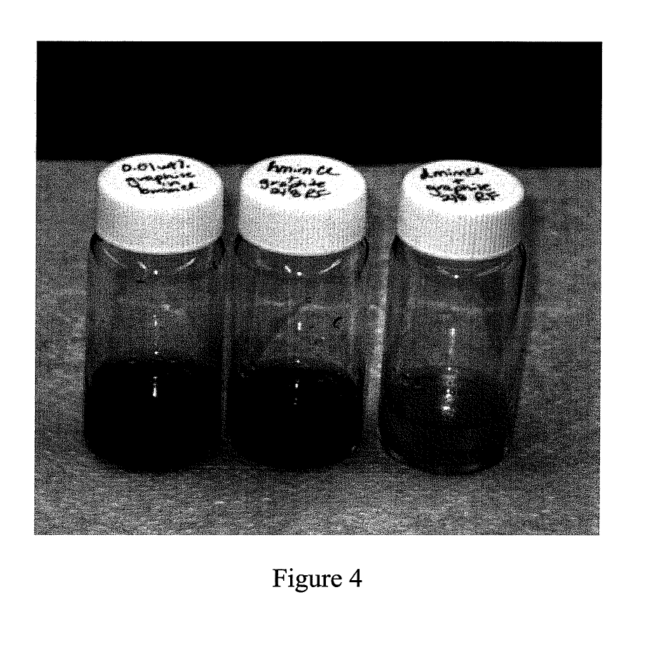

It should be appreciated that the choice of ionic liquid can impact the conversion of graphite to graphene. 0.01wt % graphite was incorporated into 1-butyl 3-methylimidazolium chloride, 1-hexyl 3-methylimidazolium chloride, and 1-decyl 3-methylimidazolium chloride. The solutions were sonicated for 1 hour. The solution clarity increased with increasing cation carbon chain. The results are shown in FIG. 4 (from left to right: 1-butyl 3-methylimidazolium chloride, 1-hexyl 3-methylimidazolium chloride, and 1-decyl 3-methylimidazolium chloride with suspended graphene). From dynamic light scattering measurements, the average particle size was found to decrease by three orders of magnitude for the sonicated bmimCl solution versus unsonicated (simply stirred) bmimCl solution.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1-5. (canceled)

6. A method for exfoliating graphite, the method comprising:
a. providing a mixture comprising graphite and at least one ionic liquid;
b. substantially homogenizing the mixture, thereby exfoliating graphite and providing graphene.

7. The method of claim 6, further comprising, after step (b), substantially de-homogenizing the mixture.

8. The method of claim 6, further comprising extracting the exfoliated graphite and graphene from the mixture.

9. (canceled)

10. The method of claim 6, wherein substantially homogenizing the mixture comprises agitating the mixture for a period of time sufficient to exfoliate graphite and substantially homogenize the mixture.

11. The method of claim 6, wherein substantially homogenizing the mixture comprises sonicating the mixture for a period of time sufficient to exfoliate graphite and substantially homogenize the mixture.

12. The method of claim 6, wherein the method does not comprise applying an electrical current to the mixture.

13. The method of claim 6, wherein the method does not comprise applying an electrical potential between two graphitic electrodes.

14. (canceled)

15. A method for making a polymer composite comprising exfoliated graphite and graphene, the method comprising:
a. providing a first mixture comprising a polymer and a solvent;
b. providing a precursor mixture comprising graphite and at least one ionic liquid and substantially homogenizing the precursor mixture, thereby providing a second mixture comprising exfoliated graphite and graphene and the at least one ionic liquid; and
c. mixing the first mixture with the second mixture to provide a third mixture, thereby making the polymer composite comprising exfoliated graphite and graphene.

16. The method of claim 15, wherein the first mixture comprises a substantially homogenous mixture.

17. (canceled)

18. (canceled)

19. The method of claim 17, wherein substantially homogenizing the precursor mixture comprises agitating the mixture for a period of time sufficient to substantially homogenize the mixture.

20. The method of claim 17, wherein substantially homogenizing the precursor mixture comprises sonicating the mixture for a period of time sufficient to substantially homogenize the mixture.

21. The method of claim 17, wherein the method does not comprise applying an electrical current to the precursor mixture.

22. The method of claim 17, wherein the method does not comprise applying an electrical potential between two graphitic electrodes.

23. The method of claim 15, further comprising extracting the polymer composite from the third mixture.

24. The method of claim 15, further comprising providing a film of the polymer composite.

25. (canceled)

26. The method of claim 7, wherein substantially de-homogenizing the mixture comprises centrifugation.

27. The method of claim 6, wherein the at least one ionic liquid comprises a 1-(C_{1-C}16-alkyl)-3-(methyl)-imidazolium cation and an anion.

28. The method of claim 6, wherein the at least one ionic liquid comprises 1-butyl-3-methylimidizaloium chloride, 1-pentyl-3-methylimidizaloium chloride, 1-hexyl-3-methylimidizaloium chloride, 1-heptyl-3-methylimidizaloium chloride, 1-octyl-3-methylimidizaloium chloride, 1-nonyl-3-methylimidizaloium chloride, 1-decyl-3-methylimidizaloium chloride, 1-hexadecyl-3-methylimidizaloium chloride, or a combination thereof.

29. The method of claim 15, wherein the at least one ionic liquid comprises a 1-(C_{1-C}16-alkyl)-3-(methyl)-imidazolium cation and an anion.

30. The method of claim 15, wherein the at least one ionic liquid comprises 1-butyl-3-methylimidizaloium chloride, 1-pentyl-3-methylimidizaloium chloride, 1-hexyl-3-methylimidizaloium chloride, 1-heptyl-3-methylimidizaloium chloride, 1-octyl-3-methylimidizaloium chloride, 1-nonyl-3-methylimidizaloium chloride, 1-decyl-3-methylimidizaloium chloride, 1-hexadecyl-3-methylimidizaloium chloride, or a combination thereof.
